(19) United States
(12) Patent Application Publication
(10) Pub. No.: US 2020/0358080 A1
(43) Pub. Date: Nov. 12, 2020

(54) NEGATIVE ELECTRODE ACTIVE MATERIAL FOR SOLID BATTERY, NEGATIVE ELECTRODE USING THE ACTIVE MATERIAL, AND SOLID BATTERY

(71) Applicant: HONDA MOTOR CO., LTD., Tokyo (JP)

(72) Inventors: Hiroto MAEYAMA, Saitama (JP); Noriaki KAMAYA, Saitama (JP); Kazuki CHIBA, Saitama (JP)

(21) Appl. No.: 16/867,578

(22) Filed: May 6, 2020

(30) Foreign Application Priority Data
May 10, 2019 (JP) 2019-090096

(51) Int. Cl. H01M 4/133

(52) U.S. Cl. CPC H01M 4/133; H01M 2004/021

(57) ABSTRACT

To provide a negative electrode active material for a solid battery capable of suppressing a micro-short circuit in a solid battery resulting in enabling a yield at the time of manufacturing to be improved, and enhancing an energy density of the resulting solid battery, even when a blending amount of the electrode active material is increased, and a solid electrolyte layer is made to be thin, a negative electrode using the active material, and a solid battery. The physical property and the blending proportion of the negative electrode active material to be used for a negative electrode layer are set to predetermined ranges.

Specifically, to provide a negative electrode active material for a solid battery, wherein a particle diameter D10 satisfies the following formula (1), a particle diameter D90 satisfies the following formula (2), and a particle diameter D50 satisfies the following formula (3) wherein, in the formulae (1), (2), and (3), D10, D50, and D90 are particle diameters in which the cumulative volume percentage in the volume particle size distribution are 10% by volume, 50% by volume, and 90% by volume, respectively, and d is an average thickness (μm) of a solid electrolyte layer when being made into a solid battery.

6 μm≤D10 (1)

D90/2<d (2)

10 μm≤D50 (3)

This application is based on and claims the benefit of priority from Japanese Patent Application No. 2019-090096, filed on 10 May 2019, the content of which is incorporated herein by reference.

### BACKGROUND OF THE INVENTION

### Field of the Invention

The present invention relates to a negative electrode active material for a solid battery, a negative electrode using the active material, and a solid battery.

### Related Art

Conventionally, lithium ion secondary batteries have been widely available as secondary batteries having a high energy density. A lithium ion secondary battery has a structure in which a separator is disposed between a positive electrode and a negative electrode, and a liquid electrolyte (electrolytic solution) is filled.

Since the electrolytic solution in the lithium ion secondary battery is usually a flammable organic solvent, in particular, the safety against heat may be a problem. Therefore, a solid secondary battery using an inorganic solid electrolyte in place of an organic liquid electrolyte has been proposed.

In such a solid secondary battery, it is known that graphite or amorphous carbon is used for a negative electrode active material (see Patent Document 1).

However, when amorphous carbon having small true density is used, a volumetric energy density of a negative electrode layer cannot be increased, thus making it difficult to increase an energy density of the solid secondary battery.

Furthermore, for example, in a case where only graphite is used as a negative electrode active material, solid secondary batteries suitable for high rate charging have been proposed by controlling confining pressure of a battery element, porosity of a negative electrode active material layer, orientation property of a negative electrode active material layer, and hardness of a negative electrode active material (see Patent Document 2).

However, when a solid electrolyte layer provided between a positive electrode and a negative electrode is made to be thin while a blending proportion of the electrode active materials necessary for increasing the energy density of the solid secondary battery is increased, a short circuit may occur at the time of manufacture of the solid secondary battery or at the time of confining battery elements. Thus, it has been difficult to manufacture solid secondary batteries with a high yield. In addition, the confining pressure of battery elements is controlled in order to reduce the porosity. When the confining pressure is high when the solid secondary battery is formed into a battery pack, there is a possibility that the battery pack becomes large to cause disadvantageous in terms of volume and weight.

Herein, methods of increasing the energy density of a solid secondary battery and reducing resistance of the battery include one method of reducing a thickness of the solid electrolyte layer so as to reduce a thickness of a unit cell, and increasing the number of stacked layers of the solid battery, while eliminating materials that inhibit conduction of lithium ions as much as possible. Another method for increasing the energy density of a solid secondary battery is a method of increasing the ratio of an active material in the negative electrode layer in the battery.

However, as described in Patent Documents 1 and 2, when the solid electrolyte layer is made to be thin, and the blending amount of the electrode active material is increased, there may be a case where the electrode active materials penetrate through the solid electrolyte layer at the time of manufacture of the solid battery, and the active material of the negative electrode layer and the active material of the positive electrode layer are brought into contact with each other to cause a micro-short circuit.

FIG. 1 shows a sectional view of a solid battery. In FIG. 1, a solid battery 10 is a laminate including a positive electrode including a positive electrode current collector 11 and a positive electrode active material 12, a solid electrolyte 13, and a negative electrode including a negative electrode active material 14 and a negative electrode current collector 15.

As shown in FIG. 1, when a layer of the solid electrolyte 13 is made to be thin, and the blending amount of the electrode active material is increased, there may be a case where at the time of manufacture of the solid battery, the electrode active materials penetrate through the solid electrolyte layer, and the active material of the negative electrode layer and the active material of the positive electrode layer are brought into contact with each other to cause a micro-short circuit. In FIG. 1, in a circular region shown by a broken line, the negative electrode active material 14 penetrates through the layer of the solid electrolyte 13 to come into contact with the positive electrode active material 12 to cause a short circuit.

Patent Document 1: Japanese Unexamined Patent Application, Publication No. 2012-146506

Patent Document 2: PCT International Publication No. 2014/016907

### SUMMARY OF THE INVENTION

The present invention has been made in view of the above-mentioned background art, and an object of the present invention is to provide a negative electrode active material for a solid battery capable of suppressing a micro-short circuit in a solid battery resulting in enabling a yield in manufacture to be improved, and the energy density of the obtained solid battery to be enhanced, even when a blending amount of the electrode active material is increased and a solid electrolyte layer is made to be thin; a negative electrode using the active material; and a solid battery.

The inventors of the present invention focused on an active material to be used for a solid battery. Then, they found that the above problems can be solved by setting the physical property and the blending proportion of a main component of the negative electrode active material to be used for a negative electrode layer to predetermined ranges, and have completed the present invention.

That is, the present invention is a negative electrode active material for a solid battery, wherein a particle diameter D10 satisfies the following formula (1), a particle diameter D90 satisfies the following formula (2), and a particle diameter D50 satisfies the following formula (3):

6 μm≤D10 (1)

D90/2<d (2)

10 μm≤D50 (3)

(wherein, in the formulae (1), (2), and (3), D10, D50, and D90 are particle diameters in which a cumulative volume percentage in a volume particle size distribution are 10% by volume, 50% by volume, and 90% by volume, respectively, and d is an average thickness (μm) of a solid electrolyte layer when being made into a solid battery.)

An aspect ratio of the negative electrode active material for a solid battery may be 8.0 or less.

A shape of the negative electrode active material for a solid battery may be a substantially spherical shape.

A main component of the negative electrode active material for a solid battery may be graphite.

Another invention is a negative electrode mixture for a solid battery, including the above-mentioned negative electrode active material for a solid battery, and a solid electrolyte, wherein a blending amount of the negative electrode active material for a solid battery is 50 to 72% by volume with respect to the total amount of the negative electrode mixture for a solid battery.

Still another invention is a negative electrode for a solid battery, including the above-mentioned negative electrode active material for a solid battery.

Yet another invention is a solid battery including the above-mentioned negative electrode for a solid battery, a solid electrolyte layer, and a positive electrode.

In the solid battery, solid electrolyte particles constituting the solid electrolyte layer have a particle diameter D90 in which a cumulative volume percentage in a volume particle size distribution is 90% by volume may be smaller than an average thickness (μm) of the solid electrolyte layer.

With the negative electrode active material for a solid battery of the present invention, solid batteries can be manufactured with a high yield while a micro-short circuit at the time of manufacture can be suppressed. Furthermore, since solid batteries having a thin solid electrolyte layer can be manufactured, the energy density of a solid battery can be enhanced. Furthermore, since the blending proportion of the negative electrode active materials in the negative electrode layer is high, the energy density of the solid batteries can be enhanced.

### BRIEF DESCRIPTION OF THE DRAWINGS

FIG. 1 is a sectional view of a conventional solid battery.

FIG. 2 is a sectional view of a solid battery of the present invention.

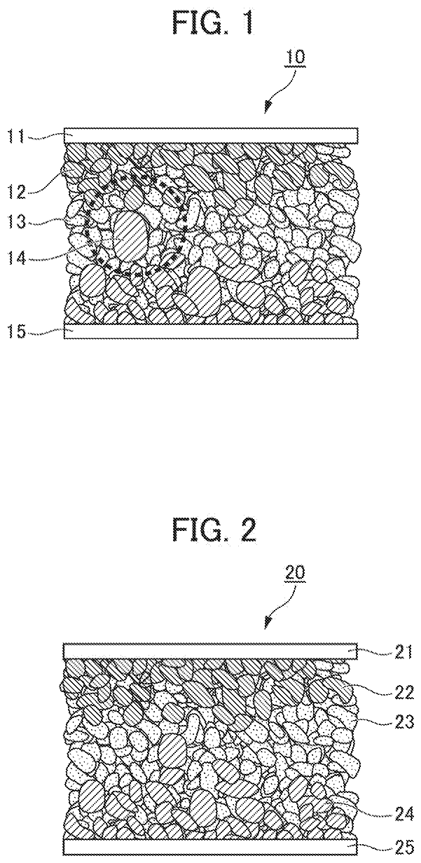

### DETAILED DESCRIPTION OF THE INVENTION

Hereinafter, embodiments of the present invention will be described.

<Negative Electrode Active Material for Solid Battery>

The present invention relates to a negative electrode active material for a solid battery, wherein a particle diameter D10 satisfies the following formula (1), a particle diameter D90 satisfies the following formula (2), and a particle diameter D50 satisfies the following formula (3):

6 μm≤D10 (1)

D90/2<d (2)

10 μm≤D50 (3)

(wherein, in the formulae (1), (2), and (3), D10, D50, and D90 are particle diameters in which a cumulative volume percentage in a volume particle size distribution are 10% by volume, 50% by volume, and 90% by volume, respectively, and d is an average thickness (μm) of a solid electrolyte layer when being made into a solid battery.)

When the negative electrode active material for a solid battery satisfies the above formulae (1), (2), and (3) simultaneously, it is possible to suppress a micro-short circuit occurring when the electrode active material penetrates through the solid electrolyte layer, and the active material of the negative electrode layer is brought into contact with the active material of the positive electrode layer at the time of manufacture. As a result, solid batteries can be manufactured with a high yield.

Furthermore, since penetration of the electrode active material through the solid electrolyte layer is suppressed at the time of manufacture, a solid battery having a thin solid electrolyte layer can be manufactured. As a result, the energy density of the solid battery can be enhanced.

In addition, in the negative electrode active material for a solid battery simultaneously satisfying the above formulae (1), (2), and (3), the blending proportion of the material in the negative electrode layer can be increased. As a result, the energy density of the obtained solid battery can be enhanced.

FIG. 2 shows a sectional view of a solid battery using the negative electrode active material for a solid battery of the present invention.

A solid battery 20 is a laminate including a positive electrode including a positive electrode current collector 21 and a positive electrode active material 22, and a negative electrode including a solid electrolyte 23, a negative electrode active material 24, and a negative electrode current collector 25.

As shown in FIG. 2, in the solid battery using the negative electrode active material for a solid battery of the present invention, even if a layer of the solid electrolyte 23 is made to be thin and the blending amount of the electrode active material is increased, at the time of manufacture of the solid battery, penetration of the electrode active material through the solid electrolyte layer is suppressed, and in turn, a micro-short circuit occurring when the active material of the negative electrode layer and the active material of the positive electrode layer are brought into contact with each other can be suppressed.

[Particle Diameter D10]

A negative electrode active material for a solid battery of the present invention has a particle diameter D10 satisfying the following formula (1). Herein, the particle diameter D10 is a particle diameter in which the cumulative volume percentage in the volume particle size distribution is 10% by volume.

6 μm≤D10 (1)

When the particle diameter D10 satisfies the formula (1), the negative electrode active material includes almost no fine particles. As a result, even if the blending proportion of the active material is increased, formation of interface between the solid electrolyte and the active material is preferably formed. Thus, lithium ion path does not become insufficient, and the energy density of the negative electrode layer can be enhanced. In the solid battery, unlike a lithium ion battery using a liquid electrolyte (electrolytic solution), solid-solid interface needs to be formed between the active material and the solid electrolyte. Therefore, when the active material includes fine particles, a specific surface area is increased, and a large amount of solid electrolytes that are in contact with the surface of the active materials is needed. Therefore, the negative electrode active material for a solid battery of the present invention needs to exclude active materials being fine particles so as to satisfy the formula (1).

Note here that in the negative electrode active material for a solid battery of the present invention, the particle diameter D10 preferably satisfies the following formula (1-2).

7 μm≤D10 (1-2)

[Particle Diameter D90]

A negative electrode active material for a solid battery of the present invention has a particle diameter D90 satisfying the following formula (2). Herein, the particle diameter D90 is a particle diameter in which a cumulative volume percentage in a volume particle size distribution is 90% by volume. Furthermore, in the following formula (2), d is an average thickness (μm) of solid electrolyte layer when a solid battery is produced using a negative electrode active material for a solid battery of the present invention for the negative electrode.

D90/2<d (2)

When the particle diameter D90 satisfies the formula (2), it is possible to suppress a micro-short circuit occurring when the negative electrode active material for a solid battery penetrates through the solid electrolyte layer, so that the active material of the negative electrode layer and the active material of the positive electrode layer are brought into contact with each other. In the solid battery, a solid electrolyte layer for separating the positive electrode and the negative electrode from each other is formed of solid electrolyte particles. Therefore, even if particle diameter of large particles in the negative electrode active material is not controlled, the possibility that the particles penetrate to cause a short circuit is increased, thus making it difficult to manufacture the particles with a high yield.

[Particle Diameter D50]

A negative electrode active material for a solid battery of the present invention has a particle diameter D50 satisfying the following formula (3). Herein, the particle diameter D50 is a particle diameter in which a cumulative volume percentage in a volume particle size distribution is 50% by volume.

10 μm≤D50 (3)

When the particle diameter D50 satisfies the formula (3), it is possible to suppress a micro-short circuit occurring when the negative electrode active material for a solid battery penetrates through the solid electrolyte layer, so that the active material of the negative electrode layer and the active material of the positive electrode layer are brought into contact with each other. Furthermore, when the particle diameter of the negative electrode active material becomes appropriate size, even if the blending proportion of the active materials is increased, formation of interface between the solid electrolyte and the active material become favorable, so that a lithium ion path does not become insufficient, and the energy density of the negative electrode layer can be enhanced.

Note here that in the negative electrode active material for a solid battery of the present invention, the particle diameter D50 preferably satisfies the following formula (3-2), more preferably satisfies the following formula (3-3), and most preferably satisfies the following formula (3-4).

11 μm≤D50 (3-2)

12 μm≤D50 (3-3)

13 μm≤D50 (3-4)

[Aspect Ratio]

In the negative electrode active material for a solid battery of the present invention, the aspect ratio (length of long axis/length of short axis) is preferably 8.0 or less. When the aspect ratio is 8.0 or less, the energy density of the negative electrode layer including the negative electrode active material for a solid battery of the present invention can be improved.

The aspect ratio (length of long axis/length of short axis) is more preferably 6.0 or less, and most preferably 3.0 or less.

[Shape]

The negative electrode active material for a solid battery of the present invention has preferably a substantially spherical shape. A substantially spherical shape can improve the energy density of the negative electrode layer including the negative electrode active material for a solid battery of the present invention.

Examples of the substantially spherical shape include a true-spherical, an oval sphere, and the like.

[Material]

The main component of the negative electrode active material for a solid battery of the present invention is preferably graphite. Graphite has a function of occluding and releasing charge carriers such as a lithium ion in the negative electrode of a solid battery. With graphite, formation of a solid battery having high energy density is facilitated by the true density and the size of the charge/discharge capacity.

The term “include . . . as a main component” means that the mass ratio of the component is the largest with respect to all components of the negative electrode active material. The ratio of graphite included in the negative electrode active material is preferably 50% by mass or more, more preferably 60% by mass or more, particularly preferably 70% by mass or more, and most preferably 100% by mass.

Examples of the graphite include high orientation graphite (HOPG), natural graphite, artificial graphite, and the like.

Furthermore, in a case where the negative electrode active material for a solid battery of the present invention includes graphite as a main component, examples of the other components include a Si simple substance, SiOx (0.3≤x≤1.6) disproportionated into two phases of a Si phase and a silicon oxide phase, and the like.

<Method for Manufacturing Negative Electrode Active Material for Solid Battery>

A method for manufacturing a negative electrode active material for a solid battery of the present invention is not particularly limited as long as the resulting negative electrode active material has physical property necessary to the present invention. For example, the negative electrode active material can be obtained by the following method.

Artificial graphite obtained by subjecting carbon materials such as coke, natural graphite, pitch, and coal to heat treatment at high temperature was firstly coarsely pulverized using Bantam mill, and then finely pulverized using a planetary ball mill to produce artificial graphite particles. Coarsely pulverized particles of the obtained artificial graphite particles are cut using a sieve to obtain artificial graphite particles having a relatively wide particle size distribution. Finally, using an air-classifying apparatus, artificial graphite having a desired particle diameter is obtained as the negative electrode active material of the present invention.

<Negative Electrode Mixture for Solid Battery>

The negative electrode mixture for a solid battery of the present invention includes the above-mentioned negative electrode active material for a solid battery of the present invention and a solid electrolyte. The solid electrolyte included in the negative electrode mixture layer is preferably an inorganic solid electrolyte such as an oxide solid electrolyte and a sulfide solid electrolyte. Among them, since lithium ion conductivity is high and formation of interface with an active material is easy, a sulfide solid electrolyte is desirable. Note here that the negative electrode mixture for a solid battery of the present invention is only required to include at least a negative electrode active material for a solid battery of the present invention and a solid electrolyte, and arbitrarily may include other components such as a conductive auxiliary agent and a binding agent.

(Blending Amount of Negative Electrode Active Material for Solid Battery)

In the negative electrode mixture for a solid battery of the present invention, the blending amount of the negative electrode active material for a solid battery of the present invention is 50 to 72% by volume with respect to the total amount of negative electrode mixture for a solid battery. In a case where a negative electrode mixture is produced using the negative electrode active material for a solid battery of the present invention, for example, even when an average thickness of the solid electrolyte layer is thin such as 20 to 50 μm, high blending such as 50 to 72% by volume can be achieved while a micro-short circuit at the time of manufacture is suppressed.

Therefore, with the negative electrode mixture for a solid battery of the present invention, since a solid battery having a thin solid electrolyte layer can be manufactured, the energy density of the obtained solid battery can be enhanced. Furthermore, when the blending proportion of the negative electrode active material is increased, the energy density of the obtained solid battery can be enhanced.

The blending amount of the negative electrode active material for a solid battery of the present invention in the negative electrode mixture for a solid battery is preferably 50 to 67% by volume with respect to the total amount of the negative electrode mixture for a solid battery.

<Negative Electrode for Solid Battery>

A negative electrode for a solid battery of the present invention includes a negative electrode active material for a solid battery of the present invention. As long as the negative electrode active material for a solid battery of the present invention is included, the other configuration is not particularly limited.

Furthermore, the negative electrode for a solid battery of the present invention may include other components other than the negative electrode active material for a solid battery of the present invention. Examples of the other components include a solid electrolyte, a conductive auxiliary agent, a binding agent, and the like.

A negative electrode for a solid battery of the present invention can be obtained by, for example, coating a current collector with a negative electrode mixture for a solid battery including the negative electrode active material for a solid battery of the present invention, a solid electrolyte, a conductive auxiliary agent, and a binding agent, and drying thereof. Note here that the negative electrode mixture for a solid battery may be the above-mentioned negative electrode mixture for a solid battery of the present invention.

Note here that the porosity in the negative electrode for a solid battery of the present invention is not particularly limited, but it is preferably 15% or less. The porosity is more preferably 10% or less, and most preferably 5% or less.

When the porosity in the negative electrode for a solid battery is 15% or less, an air gap between active material particles and solid electrolyte particles, and an air gap between the solid electrolyte particles is reduced, and thus excellent ion path is obtained. As a result, the resistance of the battery is reduced, so that electrodeposition of lithium during charging does not easily occurs. Thus, solid batteries having high reliability can be obtained.

Furthermore, when the electrode includes a large number of air gaps, the density of the electrode becomes smaller, and therefore batteries having high energy density are not easily obtained. It is preferable that the porosity is set to 15% or less because batteries having high energy density are obtained.

<Solid Battery>

A solid battery of the present invention is a laminate including a negative electrode for a solid battery of the present invention, a positive electrode, and a solid electrolyte provided between the positive electrode and the negative electrode. In the solid battery of the present invention, the other configuration is not particularly limited as long as it uses a negative electrode for a solid battery of the present invention including a negative electrode active material for a solid battery of the present invention.

[Positive Electrode]

A positive electrode constituting a solid battery usually includes a positive electrode active material and a solid electrolyte, and arbitrarily includes a conductive auxiliary agent, a binding agent, and the like. A compound constituting the positive electrode of the solid battery usually exhibits a noble potential as compared with the charge/discharge potential of the compound constituting the negative electrode.

In the solid battery of the present invention, by selecting a positive electrode material which provides a sufficiently high standard electrode potential with respect to the standard electrode potential of the negative electrode for a solid battery including the negative electrode active material for a solid battery of the present invention, the property as a solid battery are high and a desired battery voltage can be achieved.

[Solid Electrolyte Layer]

A solid electrolyte layer constituting a solid battery is provided between a positive electrode and a negative electrode, and carries out ion conduction between the positive electrode and the negative electrode. Examples of the solid electrolyte constituting a solid electrolyte layer include an oxide solid electrolyte and a sulfide solid electrolyte. In the present invention, since lithium ion conductivity is high and formation of an interface with an active material is easy, a sulfide solid electrolyte is desirable.

(Particle Diameter D90)

In the a solid electrolyte layer constituting a solid battery of the present invention, a particle diameter D90 in which the cumulative volume percentage in the volume particle size distribution is 90% by volume is preferably smaller than the average thickness (μm) of the solid electrolyte layer. The particle diameter D90 being smaller than the average thickness (μm) of the solid electrolyte layer makes it possible to form a smooth solid electrolyte layer with little unevenness. As a result, variation of resistance in the electrode is mitigated, a region where the electrode is locally deteriorated in use is reduced, and thus a highly reliable all-solid state battery can be obtained.

Furthermore, in the solid electrolyte layer constituting a solid battery the present invention, a particle diameter D90 in which the cumulative volume percentage in the volume particle size distribution is 90% by volume is preferably less than 20 μm. The solid electrolyte particle D90 of 20 μm or less makes it possible to make a solid electrolyte layer thin. When D90 is larger than 20 μm, the average thickness of the solid electrolyte layer cannot be made to less than 20 μm.

D90 of a solid electrolyte particle constituting a solid electrolyte layer is preferably less than 15 μm, and most preferably less than 10 μm. Furthermore, D90 of the solid electrolyte constituting a solid battery of the present invention is preferably 0.1 μm or more from the viewpoint of handling.

### EXAMPLES

Next, Examples of the present invention are described, but the present invention is not limited to these Examples.

### Examples 1 to 5 and Comparative Examples 1 to 3

[Manufacture of Negative Electrode Active Material for Solid Battery]

Artificial graphite (graphite) including a coke as a raw material was prepared as a material as a negative electrode active material, coarsely pulverized using Bantam mill, and then finely pulverized using a planetary ball mill to obtain artificial graphite particles. In the obtained artificial graphite particles, coarse powder was cut with a sieve having a mesh size of 62 μm, artificial graphite particles having particle size distribution of D10=6 μm, D50=28 μm, and D90=52 μm were obtained. Then, negative electrode active materials for a solid battery of Examples 1 to 4 and Comparative Examples 1 to 3 having particle diameters D10, D50, and D90 shown in Table 1 were obtained using an air classifier. The aspect ratios of the obtained negative electrode active materials for a solid battery are shown in Table 1.

TABLE 1

| | | | | | | Average | | |
|---|---|---|---|---|---|---|---|---|
| | | | | | Blending | thickness | | Electrode- |
| | Particle | Particle | Particle | Aspect | proportion | of solid | Short- | position |
| | diameter | diameter | diameter | ratio | of active | electrolyte | circuit at | behavior |
| | D10 | D50 | D90 | of active | material | layer | the time of | during |
| | (μm) | (μm) | (μm) | material | (Vol %) | (μm) | manufacture | charging |
| Example 1 | 6.5 | 14.0 | 28.0 | 2.9 | 72.0 | 20 | Not observed | Not observed |
| Example 2 | 7.0 | 13.0 | 19.8 | 3.2 | 72.0 | 20 | Not observed | Not observed |
| Example 3 | 6.5 | 22.0 | 39.0 | 4.8 | 72.0 | 20 | Not observed | Not observed |
| Example 4 | 7.5 | 18.0 | 31.5 | 2.9 | 72.0 | 20 | Not observed | Not observed |
| Comparative | 6.5 | 14.0 | 28.0 | 2.9 | 72.0 | 10 | Observed | — |
| Example 1 | | | | | | | | |
| Comparative | 18.0 | 24.0 | 41.6 | 6.0 | 72.0 | 20 | Observed | — |
| Example 2 | | | | | | | | |
| Comparative | 3.0 | 12.1 | 15.0 | 3.3 | 72.0 | 20 | Not observed | Observed |
| Example 3 | | | | | | | | |

<Production of Solid Battery>

Solid batteries were produced using the following materials by the following method.

[Manufacture of Negative Electrode for Solid Battery]

The above-obtained negative electrode active materials for a solid battery, Li2S-P2S5-based glass ceramics (D50=3.0 μm) including LiI as a sulfide solid electrolyte, and SBR as a binding agent were weighed in a mass ratio of 75:24:1. Dehydrated xylene as a solvent was added, and the obtained product was mixed using a rotation-revolution type mixer to obtain a slurry. The mixing conditions were 2000 rpm for four minutes.

The obtained slurry was applied on an SUS foil using an applicator, and dried at 110° C. for 30 minutes to produce a negative electrode for a solid battery. The applied amount was 7.5 mg/cm2. The blending proportion (% by volume) of the above-obtained negative electrode active material for a solid battery in the obtained negative electrode for a solid battery is shown in Table 1.

[Manufacture of Positive Electrode for Solid Battery]

An NCM ternary positive electrode active substance LiNi1/3Co1/3Mn1/3O2 (D50=3.4 μm) the surface of which was coated with LiNbO3 having a thickness of 5 nm, Li2S—P2S5 glass ceramics (D50=3.0 μm) including LiI as a sulfide solid electrolyte, acetylene black as a conductive auxiliary agent, and SBR as a binding agent were weighed in the mass ratio of 75:22:3:2. Dehydrated xylene as a solvent was added, and the obtained product was mixed using a rotation-revolution type mixer to obtain a slurry. The mixing conditions were 2000 rpm for four minutes.

The obtained slurry was applied on an Al foil using an applicator, and dried at 110° C. for 30 minutes to produce a positive electrode for a solid battery. The applied amount was 10.4 mg/cm2.

[Manufacture of Solid Electrolyte Layer for Solid Battery]

Li2S—P2S5 glass ceramics (D50=4 μm) including LiI as a sulfide solid electrolyte, and SBR as a binder were weighed in a mass ratio of 100:2. Dehydrated xylene as a solvent was added, and the obtained product was mixed using a rotation-revolution type mixer to obtain a slurry. The mixing conditions were 2000 rpm for two minutes.

The obtained slurry was applied on an SUS foil using an applicator, and dried at 110° C. for 30 minutes to produce a solid electrolyte layer for a solid battery.

[Solid Battery]

The negative electrode, the solid electrolyte layer, and the positive electrode, prepared as mentioned above, were cut using a 20 mm×20 mm mold, respectively. The solid electrolyte layer was stacked on the negative electrode, and pressure of 10 MPa was applied to laminate a solid electrolyte layer on the negative electrode, followed by peeling a SUS foil at the solid electrolyte layer side. Thus, the solid electrolyte layer was transferred to the negative electrode. Furthermore, the positive electrode was stacked thereon, and pressed at 100 MPa to obtain a laminate in which the negative electrode, the solid electrolyte layer, and the positive electrode had been laminated sequentially in this order.

The obtained laminate was cut using a mold having 016 mm, and pressed at 500 MPa. Subsequently, tabs for current collection were attached to the negative electrode current collector and the positive electrode current collector, respectively, and vacuum-sealed with an Al laminate to obtain a solid battery. Average thicknesses of the solid electrolyte layers of the obtained solid batteries are shown in Table 1.

<Evaluation>

The obtained solid batteries were subjected to the following evaluation.

[Presence or Absence of Short Circuit at the Time of Manufacture]

Whether a short circuit occurred during manufacturing a solid battery was checked. When a voltage between terminals of the negative electrode and the positive electrode in the solid battery which had been vacuum-sealed with an Al laminate was 0.000V, a short circuit was determined to occur in the solid battery.

[Presence or Absence of Electrodeposition Behavior During Charging]

In the obtained solid battery, a pressure of 1 MPa was applied using an SUS restraining jig in the direction in which the positive electrode, the solid electrolyte layer, and the negative electrode were laminated. Constant current charging was carried out to 4.2 V at an electric current value of 0.14 mA/cm2, and then constant current discharge was carried out to 2.7 V at electric current of 0.14 mA/cm2. When the designed charge capacity exceeded 1.2 times, it was determined that electrodeposition of lithium was observed. Note here that in Comparative Examples 1 and 2, since short circuit occurred at the time of manufacture, measurement was not able to be carried out.

### EXPLANATION OF REFERENCE NUMERALS

10, 20 solid battery
11, 21 positive electrode current collector
12, 22 positive electrode active material
13, 23 solid electrolyte
14, 24 negative electrode active material
15, 25 negative electrode current collector

What is claimed is:

1. A negative electrode active material for a solid battery, wherein
a particle diameter D10 satisfies the following formula (1),
a particle diameter D90 satisfies the following formula (2), and
a particle diameter D50 satisfies the following formula (3):
6 μm≤D10 (1)
D90/2<d (2)
10 μm≤D50 (3)
wherein, in the formulae (1), (2), and (3), D10, D50, and D90 are particle diameters in which a cumulative volume percentage in a volume particle size distribution are 10% by volume, 50% by volume, and 90% by volume, respectively, and d is an average thickness (μm) of a solid electrolyte layer when being made into a solid battery.

2. The negative electrode active material for a solid battery according to claim 1, wherein an aspect ratio of the negative electrode active material for a solid battery is 8.0 or less.

3. The negative electrode active material for a solid battery according to claim 1, wherein a shape of the negative electrode active material for a solid battery is a substantially spherical shape.

4. The negative electrode active material for a solid battery according to claim 1, wherein a main component of the negative electrode active material for a solid battery is graphite.

5. A negative electrode mixture for a solid battery, comprising the negative electrode active material for a solid battery according to claim 1, and a solid electrolyte,
wherein a blending amount of the negative electrode active material for a solid battery is 50 to 72% by volume with respect to the total amount of the negative electrode mixture for a solid battery.

6. A negative electrode for a solid battery, comprising the negative electrode active material for a solid battery according to claim 1.

7. A solid battery comprising the negative electrode for a solid battery according to claim 6, a solid electrolyte layer, and a positive electrode.

8. The solid battery according to claim 7, wherein in the solid electrolyte particle constituting the solid electrolyte layer, a particle diameter D90 in which a cumulative volume percentage in a volume particle size distribution is 90% by volume is smaller than an average thickness (μm) of the solid electrolyte layer.
